(19) United States
(12) Patent Application Publication
(10) Pub. No.: US 2007/0118759 A1
(43) Pub. Date: May 24, 2007

(54) Undesirable email determination

(76) Inventor: Scott Kenneth Sheppard, Decatur, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(21) Appl. No.: 11/245,888

(22) Filed: Oct. 7, 2005

(51) Int. Cl. H04L 9/32; G06F 11/30; G06F 12/14

(52) U.S. Cl. 713/188

(57) ABSTRACT

Included is a method for preventing spam dissemination. The method can include monitoring an Internet communication by a user, determining whether the monitored Internet communication includes a spam-related communication, and determining whether the user is a probable victim by determining whether the user is communicating via an infected device.

### BACKGROUND

As the Internet has expanded, the use of email has increased. With this increase in email use, individuals, marketers, and others have found ways to send email to millions of people regarding their products, services, causes, etc. These unwanted and unsolicited communications (text messages, instant messages, etc.) have become known as “spam.” Additionally, “fishing” (or “phishing”) scams have also become prevalent in the Internet community. At least one embodiment of a “phishing” scam is where an official looking communication, such as Hypertext Markup Language (HTML) with a corporate logo display asks for confidential information for a lost user account. The counterfeit communication can be sent to users via email or other communications means. Upon receiving a reply communication with the user's information, the “phisher” can sell the information to others or use the data for other spamming activities. In this disclosure, the term spam can be interpreted to include spam and phishing as well as other similar undesired Internet activities. The shear amount of spam received by a user can become bothersome, and the increase in traffic for an Internet Service Provider (ISP) can reduce efficiency in providing the desired services to subscribers. Additionally, the “spam problem” has become such an epidemic that many ISPs fear governmental regulation to prevent spam that originates from one or more subscribers of the ISP.

Consequently, in order to combat spam, many ISPs are currently monitoring subscriber email traffic to determine potential email spammers. This monitoring can be accomplished by vendor-supplied logic (such as Adlex/Compuware Subscriber Analysis, or Adlex/Compuware Service Check, or others) or ISP in-house logic configured to determine various properties of emails sent from an email address related to the ISP. While these properties can take many forms, typically the logic is configured to monitor the volume of emails sent by one subscriber through the ISP's mail servers over a given period of time.

Several metrics can be used by an ISP mail system to detect potential spammers. In one example, if any one subscriber sends emails to more than a predefined number of IP addresses over a given period of time, the ISP can determine that this subscriber is likely a “spammer.” One such volume determination creates a threshold where any subscriber sending SMTP port 25 traffic (email messages) to more than 20 unique IP addresses in a 24 hour period is designated as a potential spammer.

A potential spanuner list can be generated each day and may provide information about the subscriber remote authentication dial-in user service identification (RADIUS ID), the number of packets sent from the subscriber's device, and the number of packets received by the subscriber's device. The potential spammer list can also include IP addresses to which the subscriber attempted to send SMTP port 25 traffic.

Another detection scenario for subscriber traffic analysis is to find subscribers suspected to be involved with spamming or “phishing” (or both). Similar to the technique described above, one technique for detecting this activity is to inspect the application layer (layer 7) contents of a packet. If a subscriber is sending email messages to more than 20 unique subscribers with different from addresses that subscriber is likely sending spam or other malicious traffic. Upon determination that a user has exceeded the outgoing email threshold, that subscriber can then be included in a suspected spammer list.

One problem with the above described spam prevention techniques is that they do not detect spam that is being sent via the ISP through a “legacy” email account that is associated with a third party mail server. More specifically, when beginning service with an ISP, many subscribers are provided with an email address (or plurality of email addresses). While this email address is typically linked to a user account associated with the ISP, the user may have other legacy email accounts that the subscriber still uses. As a nonlimiting example, a user may begin a subscription with Big-Time Internet Service, which can provide the user with the email address user@BTIS.com. The user can send and receive email from this email address via the legacy email servers of another institution not associated with the subscribers current ISP, which can be linked with the BIG-Time mail servers. The user may also have a coldmail.com email account with email address of user2@coldmail.com, a school email account, and a work email account. The user may desire the use of all of these accounts, and at least one of these accounts may be accessible through the Internet that is being provided by Big-Time Internet Service. In such a scenario, the Big-Time Internet Service may not be able to determine whether the user is sending spam via the legacy accounts because the above described spam prevention techniques are typically not configured to analyze mail originating from a subscriber through a legacy account. Additional problems can occur when a user is undeservingly labeled as a spammer, which can occur when a subscriber is monitored solely based on the number of emails sent.

Thus, a heretofore unaddressed need exists in the industry to address the aforementioned deficiencies and inadequacies.

### SUMMARY

Included herein are systems and methods for preventing the dissemination of spam. One embodiment disclosed is a method for preventing spam dissemination that includes monitoring an Internet communication by a user and determining whether the monitored Internet communication includes a spam-related communication. In response to determining that the monitored Internet communication includes a spam-related communication, the method also includes determining whether the user is a probable victim by determining whether the user is communicating via an infected device.

Also included is a system for preventing spam dissemination. One embodiment of the system includes a server configured to provide Internet access, a user client, and a local mail server coupled to the web server, the local mail server configured to facilitate communication of a message between the user and a third party via the Internet. The system also includes a spam blocker that is configured to determine whether a message communicated to the local mail server includes a spam-related communication. Additionally this embodiment includes a traffic analyzer configured to determine whether a communication that is configured for dissemination from the user to the third party via a third party mail server(s) includes a spam-related communication, the traffic analyzer further configured to determine whether the user is a probable victim.

Similarly, also included herein is a computer readable medium for preventing the dissemination of spam. At least one embodiment of the computer readable medium includes logic configured to monitor an Internet communication associated with a user and logic configured to determine whether the monitored Internet communication includes a spam-related communication. The computer readable medium also includes logic configured to, in response to determining that the monitored Internet communication includes a spam-related communication, determine whether the user is a probable victim by determining whether the user is communicating via an infected device.

Other systems, methods, features and/or advantages will be or may become apparent to one with skill in the art upon examination of the following drawings and detailed description. It is intended that all such additional systems, methods, features and/or advantages be included within the scope of the present disclosure and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1A is a functional block diagram illustrating a configuration for allowing users to access the Internet and send email according to an exemplary embodiment.

FIG. 1B is a detailed illustration of a user device that may be used to access email or other networking tasks, similar to the user devices from FIG. 1A.

FIG. 2 is a functional block diagram illustrating an exemplary configuration of an ISP, such as one of the ISPs from FIG. 1A.

FIG. 3 is an exemplary functional flow diagram illustrating a subscriber sending email using mail servers related to the subscriber's ISP, such as an ISP from FIG. 1A.

FIG. 4 is an exemplary functional flow diagram illustrating a subscriber sending email using a third party mail server via an ISP, such as an ISP from FIG. 1A.

FIG. 5 is an illustration of an email inbox illustrating an exemplary display of various email accounts on a user device from FIG. 1A.

FIG. 6 is an illustration of an exemplary email compose page that a user may use to send an email using a device, such as a user device from FIG. 1A.

FIG. 7 is an illustration of an exemplary email compose page illustrating a user option to send an email address using any of a plurality of email accounts, such as an email account provided by an ISP from FIG. 1A.

FIG. 8A is an exemplary flowchart illustrating steps that may be taken when attempting to prevent spam via the configuration from FIGS. 3 and 4.

FIG. 8B is a continuation flowchart of the flowchart from FIG. 8A.

FIG. 9 is an exemplary Venn diagram illustrating various classes of subscribers that are sending email via an ISP from FIG. 1A.

FIG. 10 is an exemplary functional block diagram illustrating spam determination logic according to the Venn diagram from FIG. 8.

FIG. 11A is an exemplary flowchart diagram illustrating steps that may be taken to prevent spam originating from an ISP, such as an ISP from FIG. 1A.

FIG. 11B is a continuation flowchart from FIG. 11A illustrating steps that may be taken to prevent spam.

### DETAILED DESCRIPTION

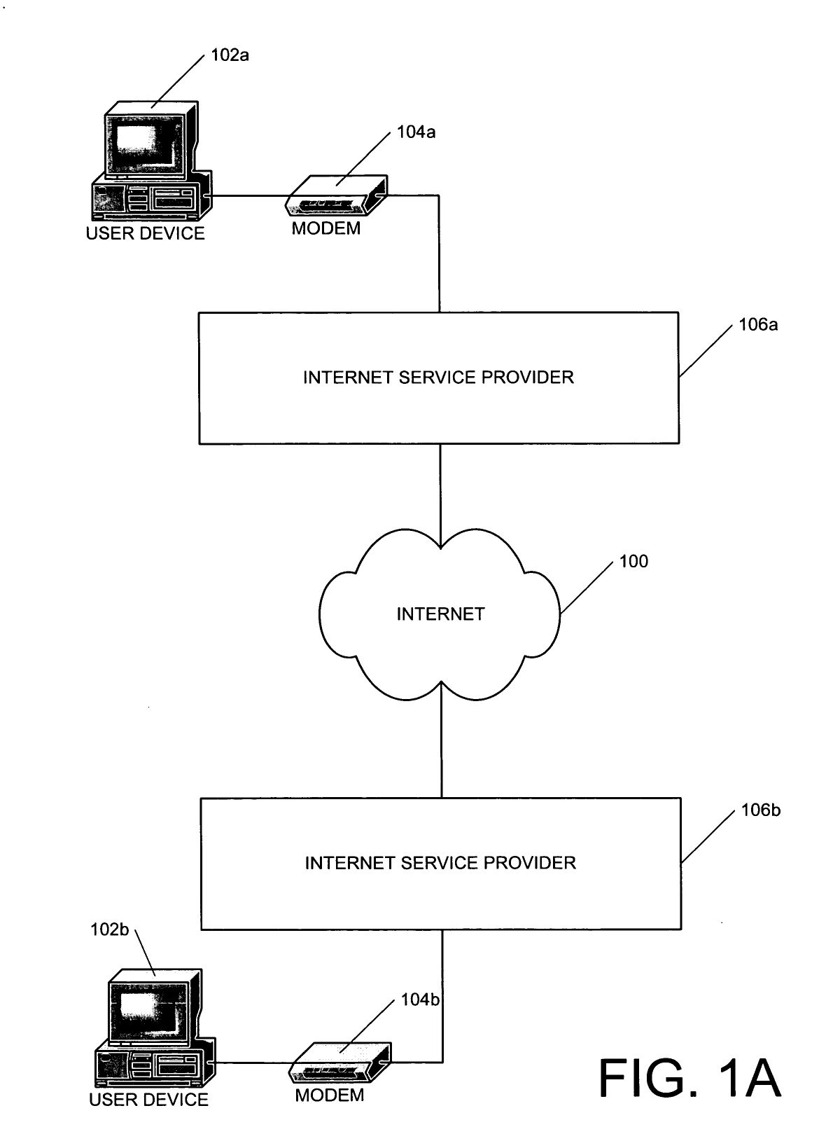

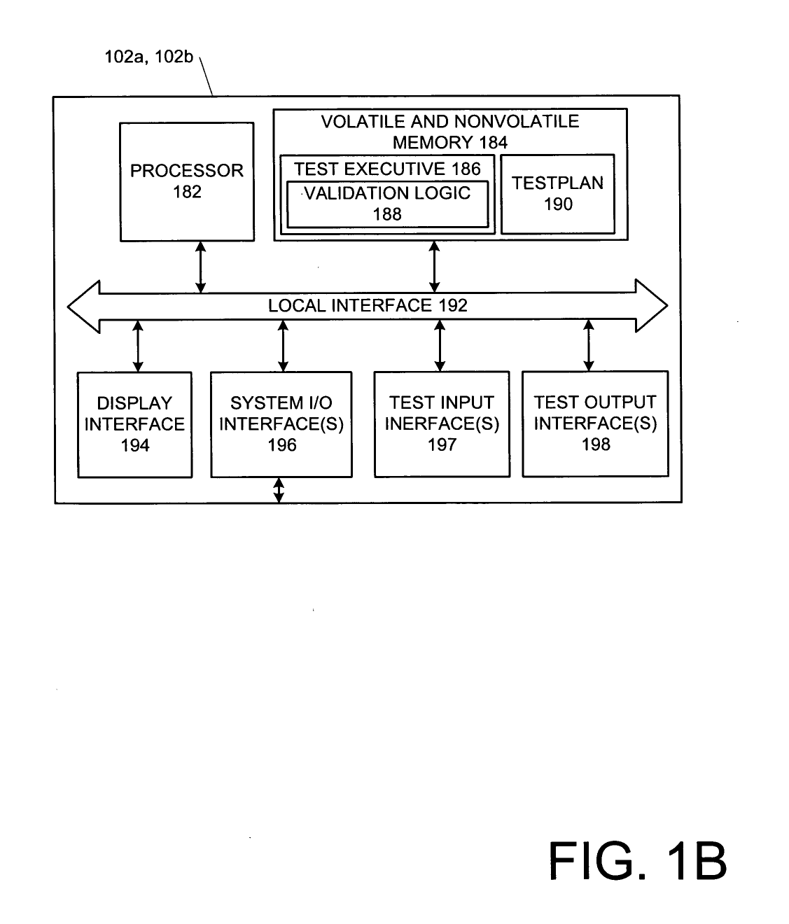

FIG. 1A is a functional block diagram illustrating a configuration for allowing users to access the Internet and send email, according to an exemplary embodiment. As illustrated in FIG. 1AA, a user may access the Internet 100 (or other network) by using his or her user device 102a. The user device 102a can be coupled to a modem 104a, that can be configured to convert data communicated over a first medium, such as cable or telephone lines to a format that is understandable by the user device 102a. While the modem 104a is illustrated as a separate component from user device 102a , this is but a nonlimiting example. Modem 104a can be an internal or external to the user device 102a and can be a device, a program, or other logic configured to perform the desired functions.

The user device 102a may also be coupled to an Internet service provider 106a, that can provide a plurality of services to the user such as Internet access, email services, instant messaging services, telephony services, etc. Similarly, the users (collectively referred to as 214, but understood to also include user devices 102a , 102b, etc.) can access the ISP 106 via other devices such as a handheld device such as a cellular telephone, pocket personal computer, a PDA, Blackberry, or other network device. The ISP 106a can connect the user device 102a to the Internet 100 (or other network). With access to the Internet 100, the user device 102a can send email messages, and other communications to user device 102b. User device 102b can also be coupled to a Modem 104b and an ISP 106b that can provide the user device 102b with similar services as the services provided to user device 102a.

One should note that while only one user device is illustrated as being coupled to each ISP 106a , 106b , this is but a nonlimiting example. Any number of users may connect to the Internet via the ISPs 106a , 106b . Similarly, while FIG. 1A illustrates a situation where a first user device 102a is communicating through a first ISP 106a via the Internet to a second user through a second ISP 106b , this is also a nonlimiting example. As is evident to one of ordinary skill in the art, a first user and a second user can be configured to access the Internet via the same ISP.

FIG. 1B is a detailed illustration of a user device that may be used to access email or other networking tasks, similar to the user devices from FIG. 1A. One should note that while wireless user devices 102a , 102b are depicted, any programmable device that can be configured for the functionality described herein might be used. As illustrated in FIG. 1B, wireless user device 102a , 102b includes a processor 182 coupled to a local interface 192.

Also coupled to the local interface 192 are a display interface 194, system input/output interface(s) 196, a test-input interface(s) 197, a test output interface(s) 198, and a volatile and nonvolatile memory 184. Included in the volatile and nonvolatile memory 184 are a text executive 186, validation logic 188, and a testplan 190.

The volatile and nonvolatile memory 184 can also store an operating system, as well as an email client, a web browser, etc. As the user device 102a , 102b navigates various networks, sends and receives, email, instant messages, and other communications, the user device 102a , 102b has the potential to acquire various malicious programs such as adware, mal-ware, etc. These programs can also be stored in the volatile and nonvolatile memory 184, and can reduce efficiency of the user device 102a , 102b as well as cause more serious problems such as device or network malfunction.

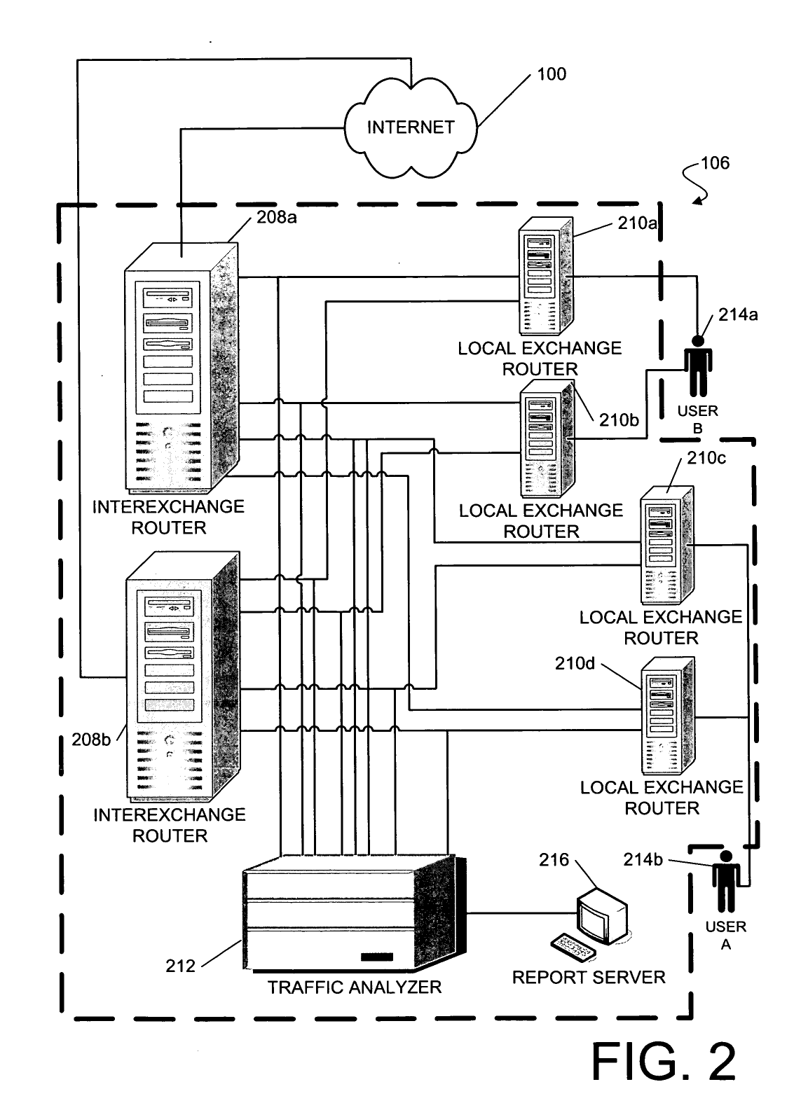

FIG. 2 is a functional block diagram illustrating an exemplary configuration of an ISP, such as one of the ISPs from FIG. 1A. As illustrated in FIG. 2, an ISP 106 can be accessed by any of a plurality of users, such as user A 214a and user B 214b. The users may communicate with the ISP 106 via a user device, such as the user devices 102a, 102b. One should note that while connections between components in the figures are illustrated as solid lines, there is no intent to limit this disclosure to wired connections. As a nonlimiting example a user device 102 can connect with an ISP or the Internet (or both) via a wired or wireless connection. Similarly, other components described herein are similarly flexible.

Included in ISP 106 are a plurality of local exchange routers 210a, 210b, 210c, 210d. The local exchange routers (collectively referred to as 210) can be a first connection point to the ISP 106 for the user 214. The local exchange routers 210 can be located anywhere within the ISP network to provide routing services for subscriber traffic. The local exchange routers 210 can be viewed as a tier 1 site and can provide access to local services (such as services provided by a Domain Name Server, Dynamic Host Protocol, and a RADIUS server, among others) to a user. Local exchange routers 210 are illustrated as being coupled to interexchange routers 208a, 208b. The interexchange routers (collectively referred as 208) can connect other geographic locations to the ISP and hence to the Internet. The interexchange routers 208 are also coupled to the Internet 100 and can effectively provide a user 214 with Internet access.

Also coupled to the local exchange routers 210 and the interexchange routers 208 is a traffic analyzer 212. In at least one embodiment, the traffic analyzer 212, among other devices, is coupled to each connection between interexchange router 208a and the local exchange routers 210. Additionally, traffic analyzer 212 is coupled to each connection between interexchange router 208b and local exchange router 210. The traffic analyzer includes many of the components illustrated in FIG. 1B, including a memory component, processor, interfaces, etc. and can be configured to monitor Internet traffic of all ISP subscribers and for monitoring inter-device communications (e.g. Boarder Gateway Protocol route updates, Service Level Agreement probe traffic, etc). An administrator (not shown) can view the data from the traffic analyzer 212 via a report server 216 (or a connected workstation) that is coupled to the traffic analyzer 212. The report server 216 can provide an administrator with copies of actual packets, packet header data, packet payload data, or other data related to the network as a whole, or for a subscriber in particular. This data can then be used to maintain and improve the functionality of the ISP 106.

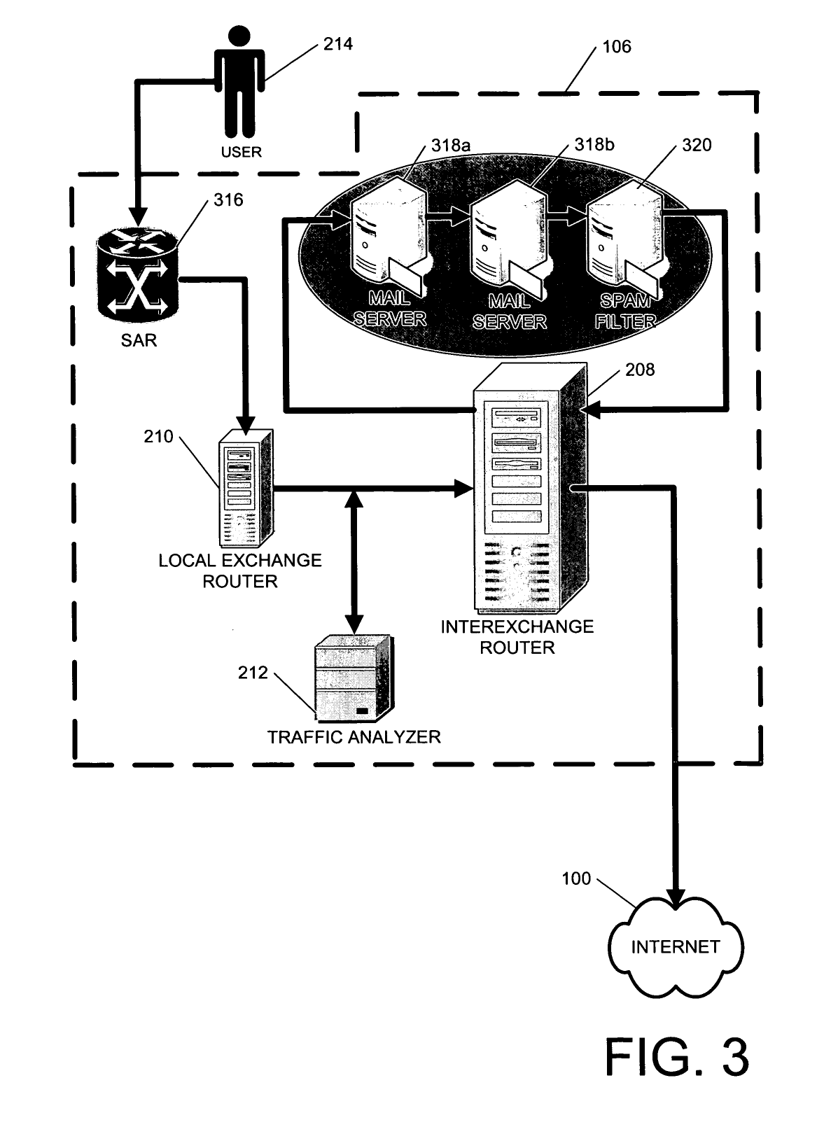

FIG. 3 is an exemplary functional flow diagram illustrating a subscriber sending email using mail servers related to the subscriber's ISP, such as an ISP from FIG. 1A. As illustrated, in at least one embodiment, a user 214 who desires to send an email (or plurality of emails) may first be required to logon to the ISP 106 via a Subscriber Aggregation Router (SAR) 316 and authenticated by an authentication application (“RADIUS” logon component not shown). The RADIUS logon component may include a database (or other type of data storage logic), and can prompt a user (or user device) for verification information. The RADIUS logon component can be located anywhere within the ISP network. The verification information can include a USERID and password, or simply user device verification. Once the user 214 is verified, he or she can access the local exchange router 210 and interexchange router 208. Traffic analyzer 212 can operate as discussed above. If the user desires to send an email via email servers related to the user's ISP, the interexchange router 208 provides access to ISP mail servers 318a, 318b. The mail servers 318a, 318bcan communicate outgoing mail messages to a spam filter 320, which can perform operations such as email volume monitoring, as discussed above. If a user violates a predetermined threshold for email volume, preventative measures can be taken to prevent the user from further use of the ISP. As stated above, this technique can have several drawbacks. These drawbacks may be cured according to exemplary embodiments described below.

Once the email has passed through the mail servers 318 and the spam filter 320, the message can be passed back to the interexchange router, which can transmit the message via the Internet to a third party mail server (not shown). Alternatively, the recipient may use the same mail server as the sender (user 214), and thus the third party mail server is not accessed.

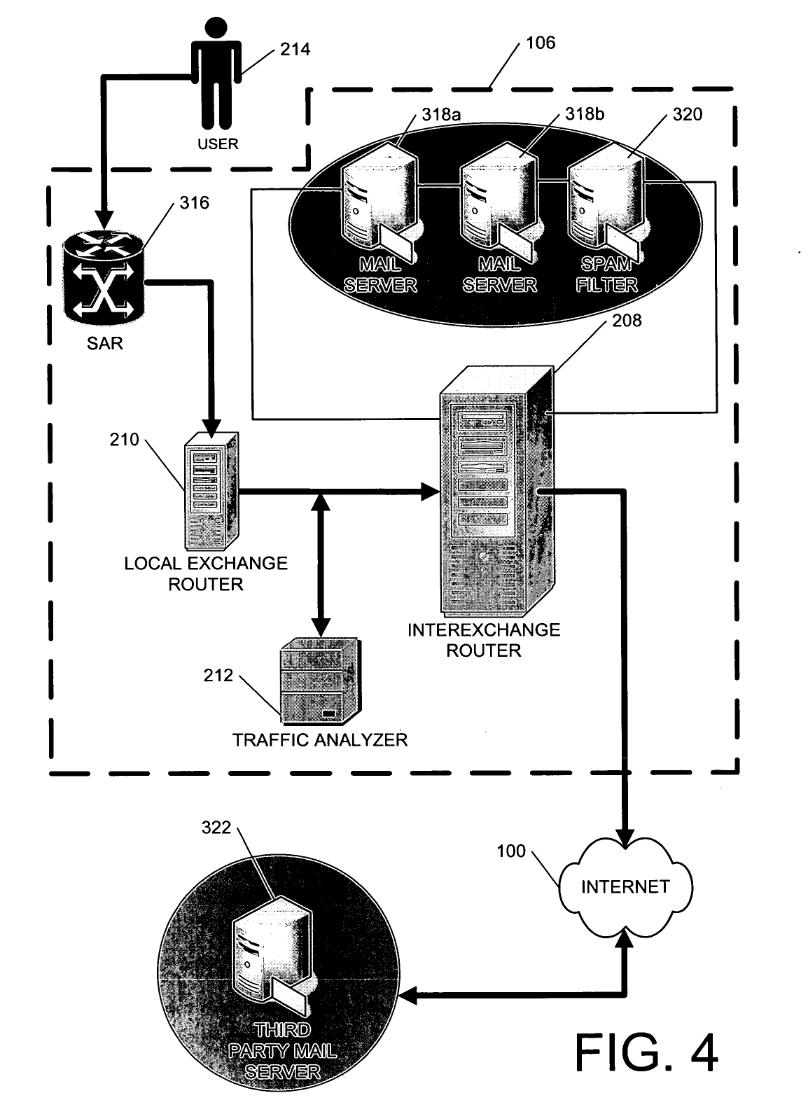

FIG. 4 is an exemplary functional flow diagram illustrating a subscriber sending email using a third party mail server via an ISP, such as an ISP from FIG. 1A. As illustrated in FIG. 3, traffic analyzer 212 can analyze traffic between the Internet 100 and the user 214. However, in this nonlimiting example, the user is sending mail via a third party server 322. Thus, the interexchange router 208 accesses the Internet 100 to provide access to a third party mail server 322. From this third party mail server 322, the user can send mail back through the Internet to a desired recipient (or recipients). Because the user 214 is accessing a mail server maintained by a third party, the local mail servers 318 (and thus the spam filter 320) are not accessed. This provides the user 214 an opportunity for spamming activities without detection from the ISP 106.

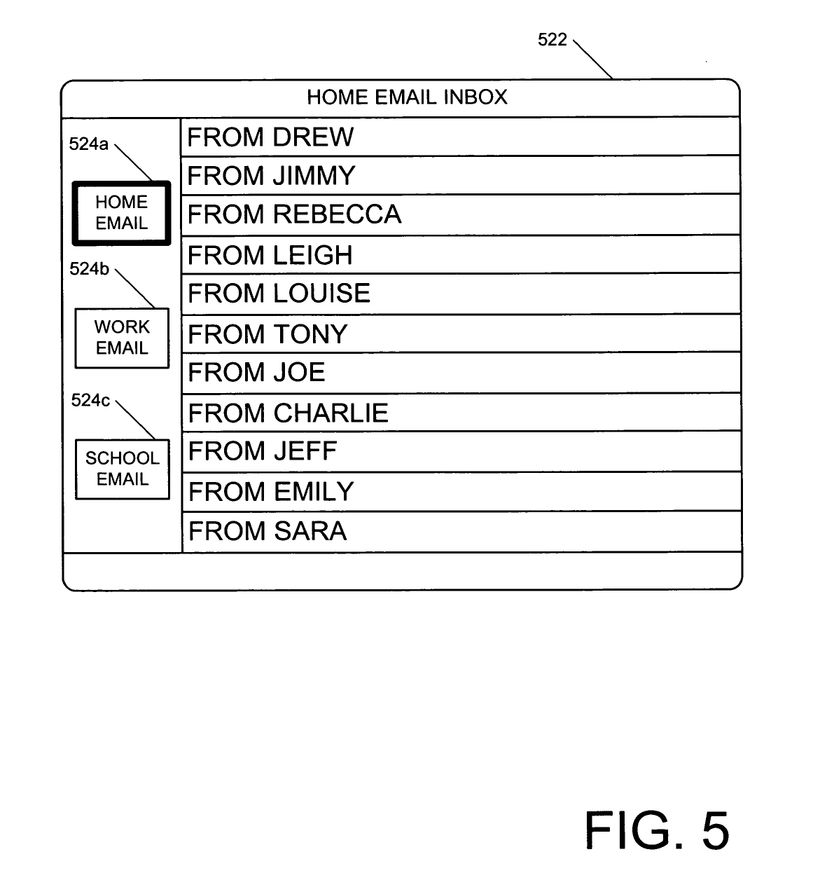

FIG. 5 is an illustration of an email inbox demonstrating a possible display of various email accounts on a user device from FIG. 1A. As illustrated in FIG. 5, the illustration 522 includes a display of various emails received at the home email address from a plurality of users. In this nonlimiting example the home email corresponds to the ISP 106 discussed above. If a user desires to send email messages via the home email address, the user device will likely access mail servers 318 and spam filter 320 (FIGS. 3, 4).

While the home email account can be accessed by selection of home email option 524a, this nonlimiting example also includes an option to view emails received by other email accounts via work email option 524b and school email option 524c. These email accounts may be provided by other sources than ISP 106, and thus may be accessed via the Internet. Such email access may also take the form of webmail, or other services that allow a user to use Internet access provided by one entity to access a mail server provided by another entity. As discussed with respect to FIG. 4, if a user sends emails via one of the email accounts that are not related to the ISP 106, the configuration illustrated in FIGS. 3, 4 will likely be unable to detect spamming activities.

One should note that while embodiments of client software may be described herein, conventional client software can also be included within the scope of this description. One intent of this description is to provide an illustration of various environments in which the subject matter described can be implemented.

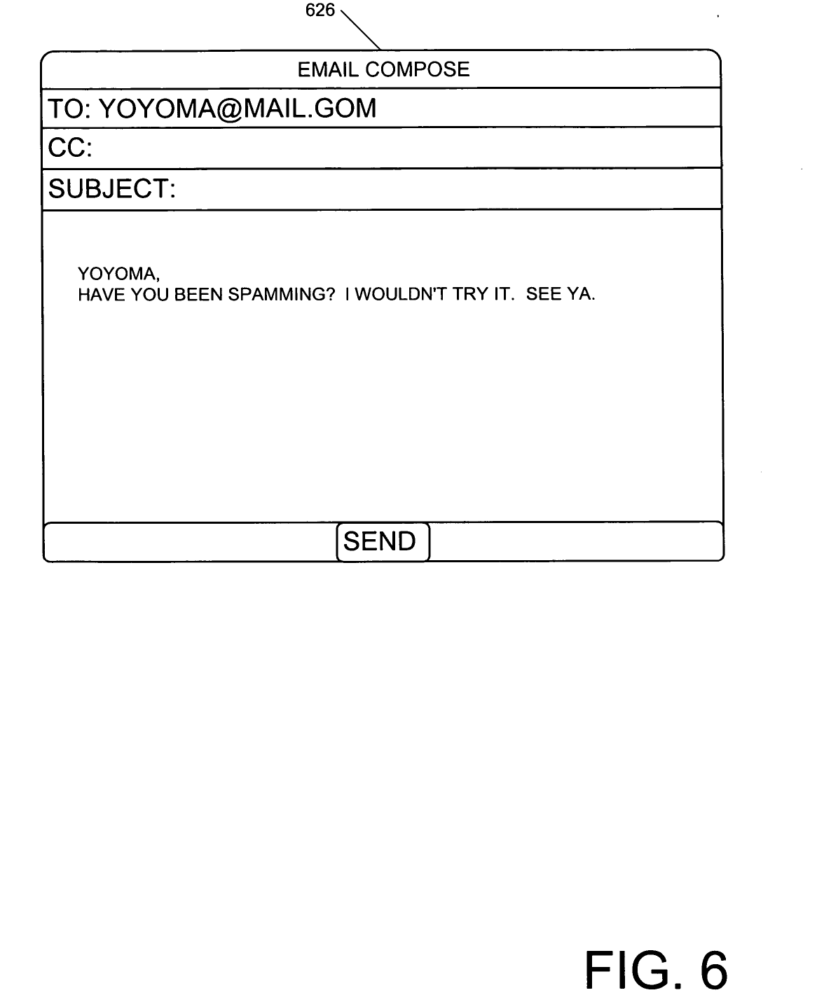

FIG. 6 is an illustration of an email compose page that a user may use to send an email using a device, such as a user device from FIG. 1A. As illustrated in FIG. 6, the email compose display 626 includes a prompt for a user to specify the recipient of the email, and an area for composing the message. Once the desired message is completed and the recipients are designated, the user may select the send option.

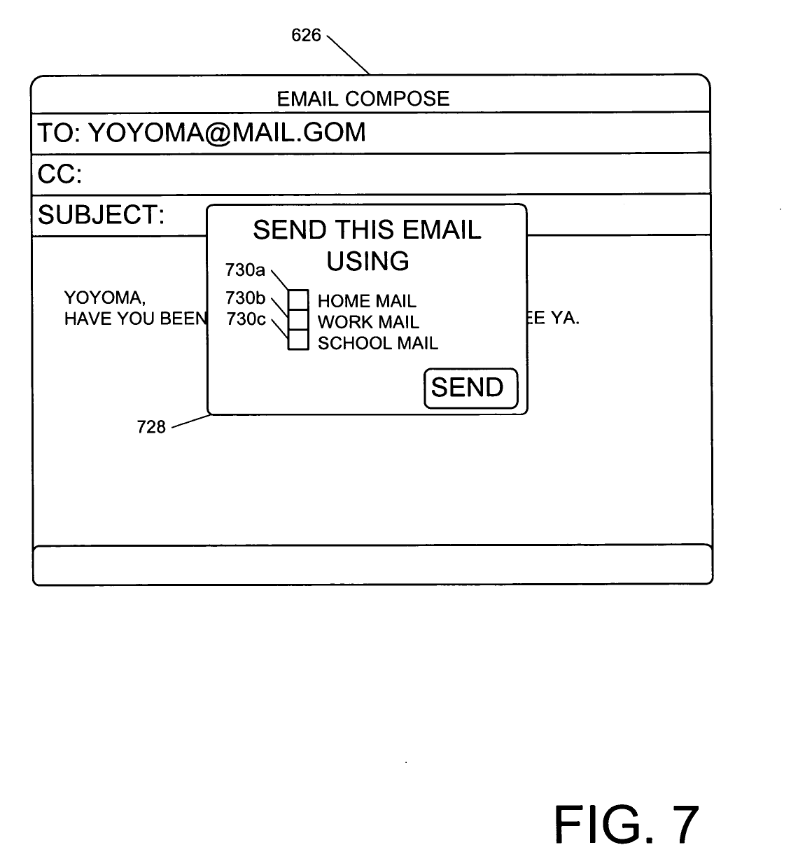

FIG. 7 is an illustration of an email compose page illustrating a user option to send an email address using any of a plurality of email accounts, such as an email account provided by an ISP from FIG. 1A. As illustrated, upon selecting the send option from FIG. 7, the user may be prompted to designate which email account the user desires that the message originate. If the user selects the home mail option 730a, the email message will likely be communicated to the desired recipient via the mail servers 318 (FIGS. 3, 4). Thus the spam filter 320 will be available to determine whether the sender of the message is engaging in spamming activities. However, if the user selects the work mail option 730b or the school mail option 730c, the user device will likely access the Internet to send the mail via a third party mail server 322. This assumes that the user is using different mail servers to send mail. As a nonlimiting example, the application may be configured to send mail from home via mail server ispl.mail.net, for work mail it might be somecompany.mail.com and for school it might be kidminder.school.mail.org. In this scenario, the ISP's mail servers 318 and spam filter 320 will likely be not be accessed, thereby reducing the ability to detect potential spamming activities.

One should note that while the description with reference to FIG. 7 describes an email client that is configured to provide a user prompt for the desired email account, this is but a nonlimiting example. As discussed above, conventional client software may be implemented to access one or more email accounts. As a nonlimiting example, the client software can default to an email account for outgoing messages. In this embodiment, the user is not prompted, but can change the desired email account for the outgoing message, if desired.

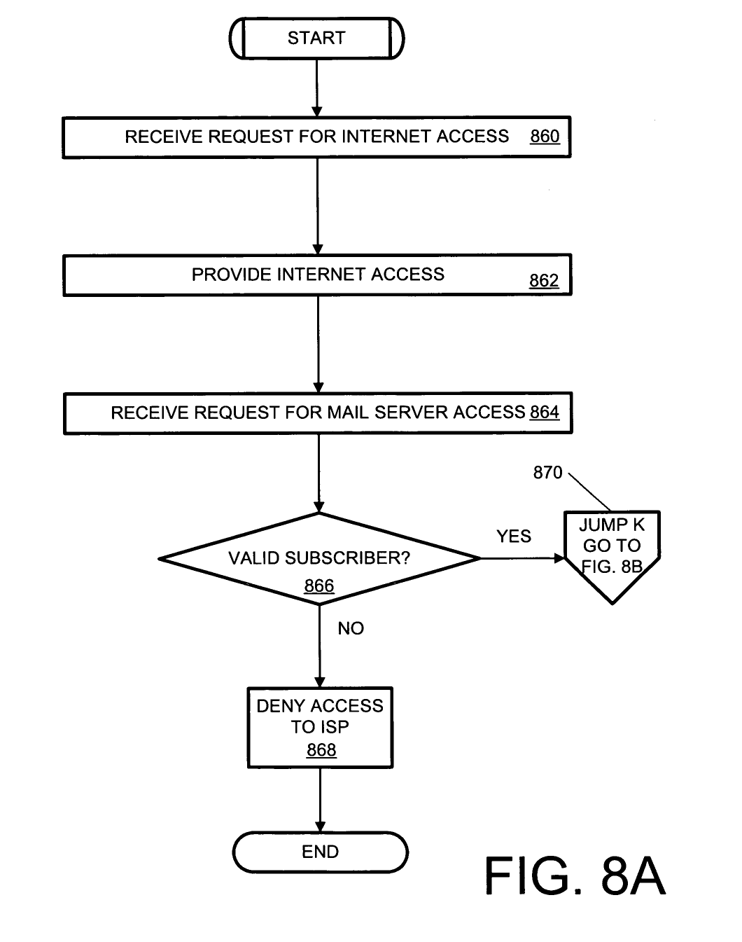

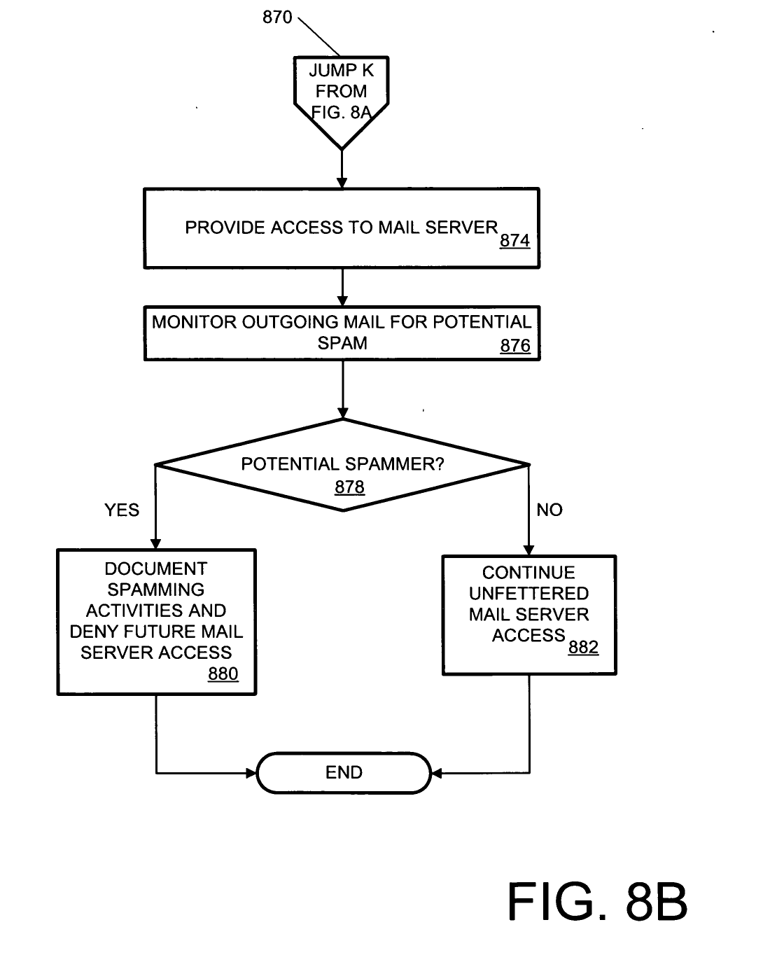

FIG. 8A is a flowchart illustrating steps that may be taken when attempting to prevent spam via the configuration from FIGS. 3 and 4. As discussed above, the ISP can receive a request for Internet access from the user (block 860). The ISP can perform an authentication procedure and provide the user with Internet access (block 862). At this point, the user can access the Internet, as well as third party mail servers (as a nonlimiting example via web mail), but normally will not have access to the local mail server 318. If the user desires access to the mail server, the user can make a request for mail server access, which can be received by the ISP 106 (block 864). The ISP 106 can then determine if the user is a valid subscriber (block 866). If the user is not valid, the user may be denied access (block 868) and the process ends. If the user is valid, the ISP 106 can facilitate the user's access to the desired mail server 318 and the flowchart proceeds to block 870, which is continued in FIG. 8B.

FIG. 8B is a continuation flowchart of the flowchart from FIG. 8A. As illustrated, if the user desires access to a mail server 318 associated with the ISP 106, the ISP 106 will then receive a request to access a mail server (block 872). The ISP 106 can monitor outgoing mail messages to and from that mail server for potential spamming activities (block 876). A determination can then be made as to whether the user is a potential spammer (block 878). If the user is determined to be a potential spammer, the ISP can document the spamming activities and deny future mail server access (block 880). If the ISP determines that the user is not participating in spamming activities, the ISP can continue granting unfettered mail server access (block 882).

As discussed above, one problem with this technique is that when a user requests only Internet access from the ISP (i.e., proceeds to block 866 from block 864), the user can generally still send mail via a third party mail server. Thus the spam detection step (block 878) is never reached, and the user can send mail without interference from the ISP. This problem may be solved according to exemplary embodiments described below.

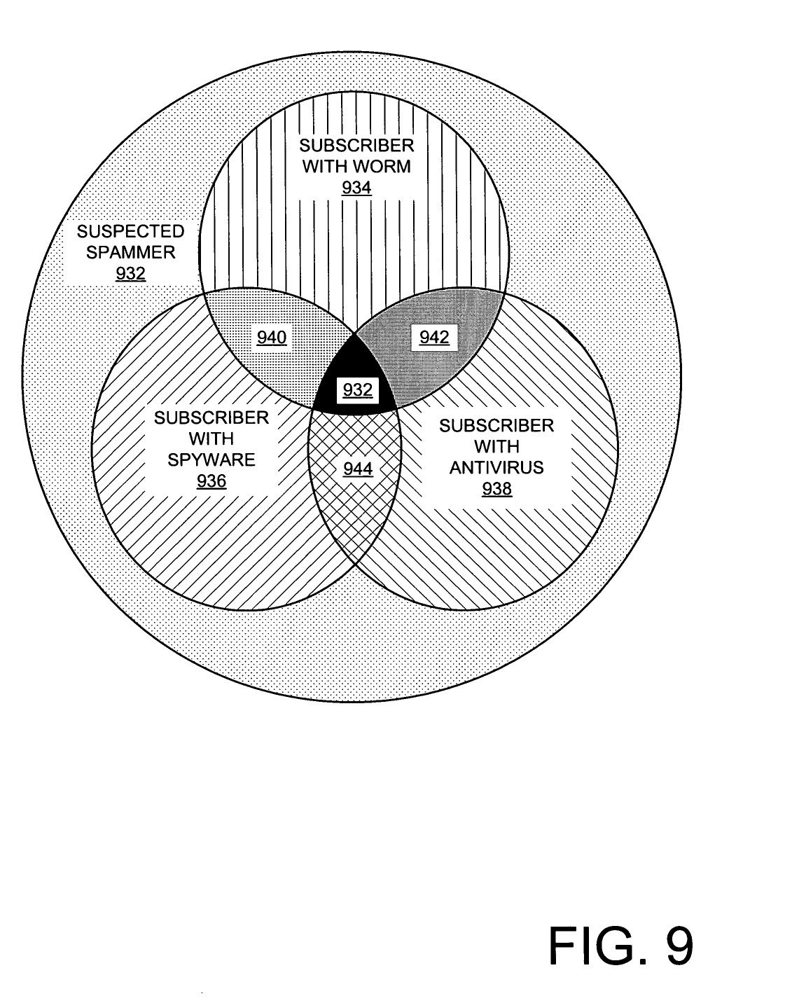

FIG. 9 is an exemplary Venn diagram illustrating various classes of subscribers that are sending email via an ISP from FIG. 1A. As stated above, one technique for determining spamming activities is to determine whether users are sending email messages to more than a predetermined number of recipients over a given period of time. The Venn diagram of FIG. 9 illustrates at least one additional technique for detecting a potential spammer. Circle 932 illustrates a pool of ISP subscribers who are engaging in activities that could be related to spamming. This pool of subscribers can be determined via the traffic analyzer 212 monitoring outgoing email volume discussed above, or from the traffic analyzer 212 monitoring other data retrieved from an email header or payload that has been sent by a subscriber.

Once the pool of suspected spammers is determined, the ISP 106 can determine which users'devices are potentially infected with a worm (section 934). In at least one embodiment this determination is made at the traffic analyzer 212 (FIG. 3) by analyzing the Internet traffic of each user. The traffic analyzer 212 can include software (such as software stored in memory) configured to determine whether a user device has a worm(s) by analyzing the packets communicated to and from the user device. In at least one embodiment, the packet header can be analyzed to determine if a user device has a worm, while in at least one other embodiment, the packet header and payload are analyzed. If a user has a worm, the packets communicated to and from the user device will generally match a certain pattern. As a nonlimiting example, a worm-infected device may communicate packets with certain characteristics, such communicating with packets of a certain size, communicating at a Transmission Control Protocol (TCP) port, communicating at a User Datagram Protocol (UDP) port, communicating payload content, communicating packets at a certain frequency, etc. With the knowledge regarding characteristics of a worm-infected device, the ISP 106 can determine which subscribers are using infected devices.

The ISP 106 can also determine which of the suspected subscribers are using a device that is infected with scum-ware, mal-ware, ad-ware (collectively referred to as “spyware”) and worms (section 936). Similar to determining whether a subscriber is infected with a worm, the traffic analyzer 212 can determine whether a subscriber is infected with spyware by analyzing packets communicated to and from a user device. If the packets match a predetermined pattern that can be associated with a spyware-infected device, the ISP can determine that the suspected subscriber's device is likely infected with spyware. Additionally, as illustrated in section 940 (and section 932), the suspected spammer can be infected with both a worm and spyware. As is evident to one of ordinary skill in the art, these categories are generally not mutually exclusive.

The ISP 106 can also determine which subscribers are using devices that have antivirus software (or logic), as illustrated in section 938. This determination can be made by the traffic analyzer 212, by comparing subscriber communications with patterns common to devices with antivirus software. Such a pattern might include the computer sending a certain packet size to a specific IP address or specific URL (website) and receiving a certain packet size from a specific IP address or specific URL (website), as is common in an antivirus update.

With this information, the ISP 106 can determine whether a suspected spammer is likely committing an act of omission, whereby the subscriber has taken few if any security measures and is thus wide open for invasion by spyware and worms. Conversely, the ISP 106 can determine whether the suspected spammer is likely committing an act of co-mission whereby the subscriber is acting with malicious intent to generate email spam traffic. These subscribers are classified as probable spammers. If the traffic analyzer 212 determines that a user has a worm, (sections 934, 940, 932, and 942) the ISP can determine that the source of the suspicious emailing patterns are likely a result of the worm, and thus the subscriber is likely a “victim.” The worm may be using the user's computer to send spam to others without the subscriber's knowledge. Similarly, if the traffic analyzer determines that the subscriber has spyware (sections 936, 940, 932, and 944), then the traffic analyzer can similarly conclude that the spyware is likely the source of the suspected spam, and that the subscriber is likely a victim. In either of these situations, the ISP can suspend the user's ISP privileges, contact the user to inform them that their computer is generating unwanted mail messages, and instruct them to remove the worm or spyware before ISP access will be resumed. As a nonlimiting example, if the ISP 106 determines that a user device is infected with spyware, the ISP can include logic (such as logic stored in traffic analyzer 212), that is configured to automatically email the user. The email can include instruction that the user can follow that will remove the infection (i.e., the spyware). The email can also include repercussions if the user does not remove the spyware. Such repercussions can include suspension of the user's account with the ISP 106, loss of email privileges, etc.

However, the subscribers that are in the suspected spammer pool 932, but who are armed with antivirus software, and are not infected with worms or spyware, are likely a spammer (section 938). The traffic analyzer can make this conclusion from the fact that there is suspect email originating from the subscriber's device, the user has antivirus software to protect against worms and spyware, and the subscriber in fact has no worms or spyware that could make the subscriber a victim. With respect to the subscribers categorized in section 938, the ISP 106 can more closely monitor the user's Internet activities (described in more detail below) and if the detailed analysis supports it, report these activities to the authorities.

If a subscriber is thought to be a victim, that subscriber's Internet traffic can be directed to a special server hosting a web site called a “sandbox.” A sandbox is a web site where the subscriber is informed that a device he or she is using is sending out port 25 SMTP email traffic that is likely spam. An application(s) is then provided to allow the subscriber to remove known worms or spyware (or both) from the subscriber's device(s). After the subscriber's device is free of worms and spyware, the subscribers RADIUS profile can again changed and the subscriber may be allowed to access the ISP without encumbrance.

In the case where a subscriber is suspected of being a deliberate spammer or in violation of other Acceptable Use Policy (AUP) standards, the subscriber may not be automatically placed in a Sandbox. While any of a number of approaches may be taken, one approach is to send packet level traffic to a special access controlled server for a perdetermined amount of time. This server can hold the actual packets sent by probable spammers, The traffic can then be analyzed with a “sniffer.” A sniffer can include logic for monitoring data traveling over a network. The sniffer can be used to verify the contents of traffic spam or “phishing” traffic or as sending infected traffic to others (worm propagation), ect. This information can then be used to re-classify the subscriber as a victim or as a stronger suspect and provide stronger secondary inspection measures.

Table 1, below illustrates logical data of possible subscriber categorizations. One should note that this is one embodiment of potential categorizations of potential spammers, as other logic could be implemented to distinguish a victim from a spammer. In Table 1“S” indicates that spyware is present on the subscriber's device. If spyware is present a “1” is entered into the S column. “W” indicates that a worm is present on the subscriber's device. If a worm is present a “1” is entered into the W column. “A” indicates that the subscriber's device is armed with antivirus software. If antivirus software is present a “1” is entered into the A column. “VICTIM” indicates that the subscriber is likely a victim and will be instructions to remove the spyware or worms from his or her device. “SPAMMER” indicates that the subscriber is likely a spammer and closer traffic monitoring can be implemented.

TABLE 1

| WSA | RESULT |
|---|---|
| 000 | VICTIM |
| 001 | SPAMMER |
| 010 | VICTIM |
| 011 | VICTIM |
| 100 | VICTIM |
| 101 | VICTIM |
| 110 | VICTIM |
| 111 | VICTIM |

As stated above, depending on the particular desires of the ISP, different logic can be implemented. As a nonlimiting example, some ISPs may desire that any suspicious subscriber who has antivirus software is not a victim, but a potential spammer, regardless of whether that subscriber is infected with spyware or a worm.

At least one other embodiment might also include collecting the worm infecting execution file (*.exe) from the customer's traffic for further analysis. One embodiment could track down the entity controlling the execution file using a “honey pot” concept or other similar technique. A honey pot can be seen as a user device with no protection (such as antivirus software, ect.) The execution file can be loaded and the packets associated with the application within the execution file can be captured.

In the case where the subscriber's infected device is running a “phishing” scam, the inspection of packet contents can lead to an IP address, subscriber account name, or the ISP that is receiving fraudulently collected data from unsuspecting users. In this case, various methods can be employed to determine the IP address that is accessing the infected subscriber's device(s) to get the data obtained from the fishing scam. In this scenario, the subscribers is a victim, in that the subscriber's device is a client and of a controlling system.

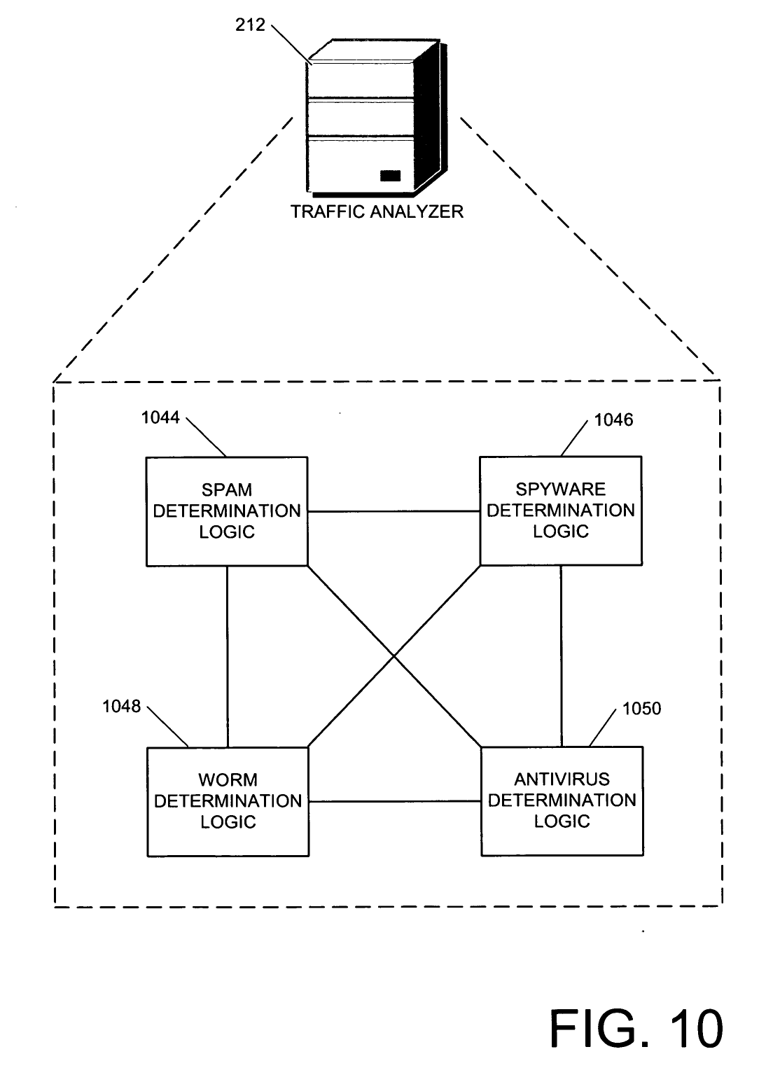

FIG. 10 is a functional block diagram illustrating spam determination logic according to the Venn diagram from FIG. 8. While the traffic analyzer 212 may have various hardware or software or both (such as a processor, data storage logic, etc.), FIG. 10 is a functional illustration of logic components that may be present. Other components can be added or removed from the traffic analyzer 212 depending on the particular desires of the ISP. As illustrated, the traffic analyzer can include spam determination logic 1044. The spam determination logic can be used to create a pool of suspected subscribers. The pool of suspected subscribers can include subscribers who have been participating in activities related to spam, as discussed above. Also included in the traffic analyzer 212 is spyware determination logic 1046. The spyware determination logic can be configured to analyze packets being sent to and received from a suspected subscriber to determine whether the subscriber's device is infected with spyware. Also included in the traffic analyzer 212 is worm determination logic 1048 configured to determine whether the suspected subscriber's device is infected with a wormn. Additionally, the traffic analyzer 212 can also include antivirus determination logic 1050 configured to determine whether the suspected subscriber's device is armed with antivirus software. With this logic, the traffic analyzer can determine a desired course of action with respect to the suspected subscriber based on the data from Table 1, above. As described above, depending on whether the subscriber is classified as a victim or a Probable Spammer, different courses of action can be taken.

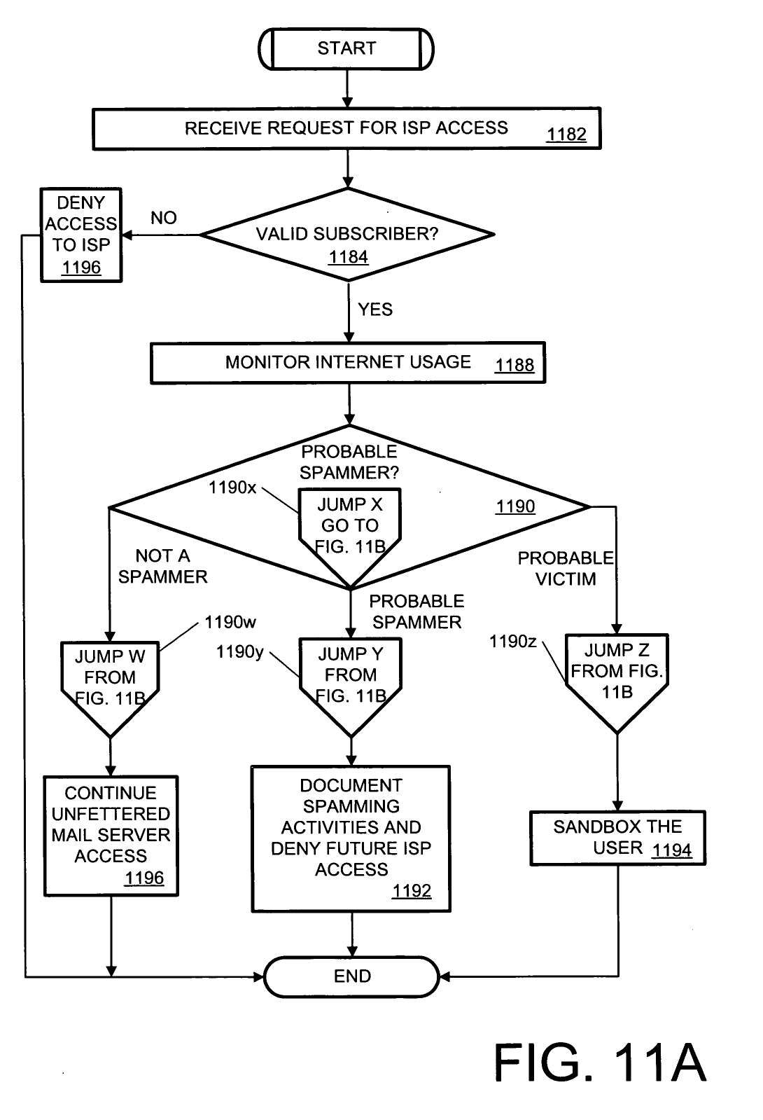

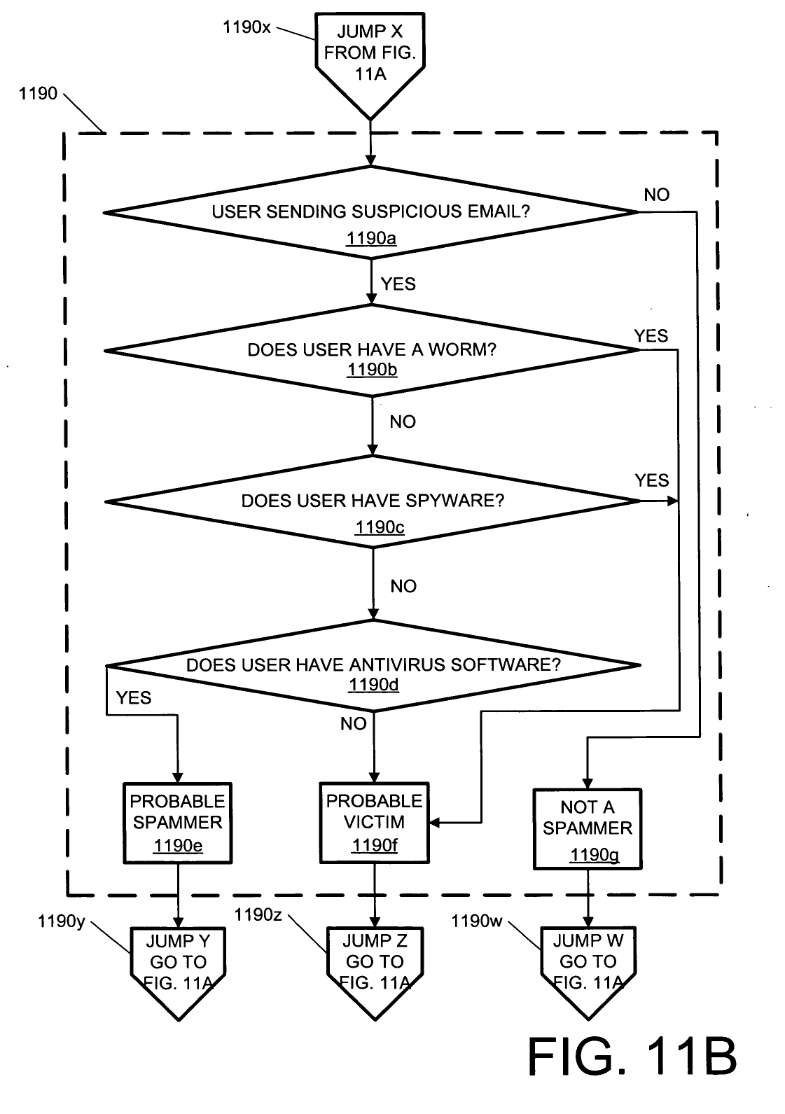

FIG. 11A is a flowchart diagram illustrating steps that may be taken to prevent spam originating from an ISP, such as an ISP from FIG. 1A. As illustrated, the first step in this nonlimiting example is to receive a request for ISP access (block 1182). A user can request ISP access by simply logging on to his or her personal computer, cell phone, Personal Digital Assistant (PDA), Blackberry®, etc. Depending on the particular configuration of the user's device, the request can be received by the ISP in any of a plurality of ways.

Next, the ISP can determine whether the user is valid by authenticating the subscriber (block 1184), as discussed above. This can take the form of a USERID and password or automatic authentication by the user device. If the user is not a valid subscriber, ISP access can be denied (block 1196), and the process can end. If the user is a valid subscriber, the ISP can begin monitoring Internet usage (block 1188) to determine whether outgoing emails and other communications are potentially spam. A determination can then be made as to whether the user is a probable spammer (block 1190, which jumps to FIG. 11B at block 1190x).

FIG. 11B is a continuation flowchart from FIG. 11A, illustrating steps that may be taken to prevent spam. This flowchart begins from block 1190x from FIG. 11A. In determining whether the user is a probable spammer, the flowchart determines whether the user is sending suspicious email (or other communications such as text messages, instant messages, etc.) as illustrated in block 1190a. The ISP can determine whether the user is sending suspicious email by an outgoing email volume analysis described above, or other technique for determining whether spam is likely being generated by a user. If the user is not sending suspicious email, then the ISP can determine that the user is not a spammer (block 1190g), and then the process can proceed to jump w (block 1190w).

If the ISP determines that the user is sending suspicious communications at 1190a, the process proceeds to determine whether the user has a worm (block 1190b). If the user has a worm, the suspicious communications that are originating from the user's device is likely the result of the worm, and ISP can determine that the user is a probable victim (block 1190f), and proceed to jump z (block 1190z). If the user does not have a worm, the ISP can determine whether the user has spyware (block 1190c). If the user does have spyware, the ISP can determine that the user is a victim (block 1190f), and then proceed to jump z (block 1190z). If the user does not have spyware, the ISP can determine whether the user has antivirus software. If the user does not have antivirus software, the ISP can determine that the user is a probable victim (block 1190f) and proceed to jump z (block 1190z). If, on the other hand the user has antivirus software, the user is classified as a probable spammer (block 1190e), and the process proceeds to jump y (block 1190y).

Returning to FIG. 11A, if the ISP determines that the subscriber is not sending suspicious email, text messages, instant messages, etc., the process proceeds from jump w (block 1190w), and the user can be allowed unfettered ISP access, as before (block 1196). If the user is determined to be a likely victim, the flowchart proceeds from jump z (block 1190z), where the ISP can “sandbox” the user as discussed above (block 1194). By “sandboxing” the user, the ISP can ensure that the spyware and worms are removed from the user's device(s), and can again grant the user ISP access. If the user is determined to be a probable spammer, the process proceeds from jump y (block 1190y) to document the spamming activities, and potentially deny future ISP access (block 1192). At this point the process can end.

One should note that, with reference to the flowcharts herein, each block represents a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially or concurrently or the blocks may sometimes be executed in the reverse order, depending upon the functionality involved.

Additionally, any of the programs listed herein, which can include an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of this disclosure can include embodying the functionality described in logic embodied in hardware or software-configured mediums.

It should be emphasized that many variations and modifications may be made to the above-described embodiments. All such modifications and variations are intended to be included herein within the scope of this disclosure and protected by the following claims.

Therefore, at least the following is claimed:

1. A method for preventing spam dissemination, comprising:
monitoring an Internet communication by a user;
determining whether the monitored Internet communication includes spam-related data; and
in response to determining that the monitored Internet communication includes spam-related data, determining whether the user is a probable victim by determining whether the user is communicating via an infected device.

2. The method of claim 1, wherein determining whether the user is a probable victim includes determining whether the user is communicating via a device that is infected with at least one of the following: a worm, spyware, and a virus.

3. The method of claim 2, further comprising in response to determining that the user is a probable victim, facilitating removal of at least one infection.

4. The method of claim 1, wherein determining whether the user is a probable victim includes determining whether the user is communicating via a device that includes antivirus logic.

5. The method of claim 1, wherein the Internet communication is configured for dissemination via a third party mail server.

6. The method of claim 1, wherein determining whether the user is a probable victim includes analyzing at least one packet communicated by the user.

7. The method of claim 1, wherein determining whether the Internet communication includes a spam-related communication includes determining whether the user has communicated a message to more than a predetermined number of recipients over a predetermined time period.

8. A traffic analyzer configured to monitor communications for spam-related data, the traffic analyzer comprising:
logic configured to monitor an Internet communication by a user;
logic configured to determine whether the monitored Internet communication includes spam-related data; and
logic configured to, in response to determining that the monitored Internet communication includes spam-related data, determine whether the user is a probable victim by determining whether the user is communicating via an infected device.

9. The traffic analyzer of claim 8, further comprising logic configured to determine whether the user is communicating via a device that is infected with at least one of the following: a worm, spyware, and a virus.

10. The traffic analyzer of claim 9, further comprising logic configured to facilitate removal of the at least one infection, in response to determining that the user is a probable victim.

11. The traffic analyzer of claim 8, further comprising logic configured to determine whether the user is communicating via a device that includes antivirus logic.

12. The traffic analyzer of claim 8, further comprising logic configured to determine whether the user is communicating to more than a predetermined number of recipients over a predetermined period of time.

13. The traffic analyzer of claim 8, further comprising logic configured to determine whether a communication that is configured for dissemination from the user to the third party via the local mail server includes a spam-related communication.

14. The traffic analyzer of claim 8, further comprising logic configured to analyze at least one packet communicated between the user and the Internet.

15. A computer readable medium for preventing the dissemination of spam, comprising:
logic configured to monitor an Internet communication associated with a user;
logic configured to determine whether the monitored Internet communication includes spam-related data; and
logic configured to, in response to determining that the monitored Internet communication includes spam-related data, determine whether the user is a probable victim by determining whether the user is communicating via an infected device.

16. The computer readable medium of claim 15, further comprising logic configured to determine whether the user is communicating via a device that includes at least one of the following: a worm, spyware, and a virus.

17. The computer readable medium of claim 15, further comprising logic configured to determine whether the user is communicating via a device that includes antivirus logic.

18. The computer readable medium of claim 15, wherein the Internet communication is configured for dissemination via a third party mail server.

19. The computer readable medium of claim 15, further comprising logic configured to analyze at least one packet communicated by the user.

20. The computer readable medium of claim 15, further comprising logic configured to determine whether the user has communicated a message to more than a predetermined number of recipients over a predetermined time period.
